(19) United States
(12) Patent Application Publication
(10) Pub. No.: US 2022/0073253 A1
(43) Pub. Date: Mar. 10, 2022

(54) CUSHION AND TRANSPORTATION PROTECTIVE DEVICE

(71) Applicants: Beijing BOE Display Technology Co., Ltd., Beijing (CN); BOE Technology Group Co., Ltd., Beijing (CN)

(72) Inventors: Liangliang ZHAO, Beijing (CN); Qiang LI, Beijing (CN); Junli ZHOU, Beijing (CN); Kaipeng FU, Beijing (CN); Pingli LI, Beijing (CN); Yang LIU, Beijing (CN); Qingyan ZHANG, Beijing (CN); Yunyun WANG, Beijing (CN); Yinlong ZHANG, Beijing (CN); Xiuli LIU, Beijing (CN)

(21) Appl. No.: 17/410,638

(22) Filed: Aug. 24, 2021

(30) Foreign Application Priority Data
Sep. 4, 2020 (CN) 202021922288.5

(51) Int. Cl. B65D 81/127; B65D 81/05; B65D 85/48; B65D 81/02

(52) U.S. Cl. CPC B65D 81/1275; B65D 65/44; B65D 85/48; B65D 81/051

(57) ABSTRACT

Provided is a cushion, including a cushion body, a first antislip film and a second antislip film, wherein a first surface of the first antislip film is connected to a first surface of the cushion body; a first surface of the second antislip film is connected to a second surface of the cushion body; the first surface of the cushion body is opposite to the second surface of the cushion body; and a second surface of the first antislip film and a second surface of the second antislip film are configured to respectively abut surfaces of two objects spaced apart by the cushion. A transportation protective device is also provided.

### CROSS-REFERENCE TO RELATED APPLICATION

This application is based on and claims priority to the Chinese Patent Application No. 202021922288.5, filed on Sep. 4, 2020 and entitled “CUSHION AND TRANSPORTATION PROTECTIVE DEVICE”, the disclosure of which is herein incorporated by reference in its entirety.

### TECHNICAL FIELD

The present disclosure relates to the field of display panel packing, and more particularly, to a cushion and a transportation protective device.

### BACKGROUND

In the transportation process of a display panel, it is necessary to place the display panel in a transportation protective device to reduce a probability of colliding and damaging the display panel. In addition, some devices need to be used for positioning and supporting the display panel placed in the transportation protective device, so as to limit the possible positions of the display panel in the transportation protective device, especially when turning, acceleration or sudden braking occurs during the transportation process, which can further reduce the probability of colliding and damaging the display panel.

### SUMMARY

The embodiments of the present disclosure aim at providing a cushion, a transportation protective device, so as to provide implementation manners for limiting the position of a display panel. The present disclosure provides the following technical solutions.

In an aspect, a cushion is provided. The cushion includes a cushion body, a first antislip film and a second antislip film;

wherein a first surface of the first antislip film is connected to a first surface of the cushion body; a first surface of the second antislip film is connected to a second surface of the cushion body; the first surface of the cushion body is opposite to the second surface of the cushion body; a second surface of the first antislip film and a second surface of the second antislip film are configured to respectively abut surfaces of two objects spaced apart by the cushion.

Optionally, at least one of the first antislip film and the second antislip film comprises a substrate and a coating that are stacked; and a target surface of the substrate is connected to the cushion body, wherein the target surface of the substrate is a surface of the substrate that is opposite to a contact surface between the substrate and the coating.

Optionally, a material of the coating includes an olefin block copolymer.

Optionally, the olefin block copolymer includes an olefin rubber added with a high molecular polymer; a ratio of the high molecular polymer to the olefin rubber is determined based on an antislip grade of the cushion.

Optionally, the material of the coating further includes an antistatic master batch.

Optionally, a material of the substrate includes a low density polyethylene.

Optionally, a thickness of the substrate is about 20 μm.

Optionally, a thickness of the coating is about 10 μm.

Optionally, the cushion body and the first antislip film are fixedly connected by hot pressing, and the cushion body and the second antislip film are fieedly connected by hot pressing.

Optionally, a thickness of the cushion is greater than or equal to 3 mm.

Optionally, a material of the cushion body includes a polyethylene foam.

In another aspect, a transportation protective device is provided. The transportation protective device includes:

a package box, configured to accommodate a display panel;

a stopper, disposed between a non-component edge of the display panel and the package box, the non-component edge being an edge of the display panel where no component is exposed;

a first cushion, wherein the first cushion includes a first cushion body, a first antislip film and a second antislip film; a first surface of the first antislip film is connected to a first surface of the first cushion body; a first surface of the second antislip film is connected to a second surface of the first cushion body; the first surface of the first cushion body is opposite to the second surface of the first cushion body; and a second surface of the first antislip film and a second surface of the second antislip film are configured to respectively abut the display panel and the package box.

Optionally, the first cushion covers an orthographic projection of the display panel onto the first cushion.

Optionally, the transportation protective device further includes a second cushion including a second cushion body, a third antislip film and a fourth antislip film; a first surface of the third antislip film is connected to a first surface of the second cushion body; a first surface of the fourth antislip film is connected to a second surface of the second cushion body; the first surface of the second cushion body is opposite to the second surface of the second cushion body; a second surface of the third antislip film and a second surface of the fourth antislip film are configured to respectively abut two adjacent display panels in the package box.

Optionally, the second cushion covers an orthographic projection of the display panel onto the second cushion.

Optionally, an extending direction of a component-exposed edge of the display panel is the same as a transportation direction of the transportation protective device, the component-exposed edge being an edge of the display panel where a component is exposed.

Optionally, a display surface of the display panel faces away from a bottom of the package box.

Optionally, the bottom of the package box is embedded with a support profile.

Optionally, the support profile includes a plurality of bar profiles embedded in the bottom of the package box in parallel.

Optionally, a material of the support profile includes aluminum.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and persons of ordinary skill in the art may derive other drawings from these accompanying drawings without creative efforts.

FIG. 1 is a schematic structural diagram of a cushion according to an embodiment of the present disclosure;

FIG. 2 is a schematic structural diagram of a first antislip film according to an embodiment of the present disclosure;

FIG. 3 is a schematic diagram of a transportation protective device according to an embodiment of the present disclosure;

FIG. 4 is a schematic structural diagram of a support profile according to an embodiment of the present disclosure;

FIG. 5 is a schematic sectional view at AA′ in FIG. 4 according to an embodiment of the present disclosure.

### DETAILED DESCRIPTION

Descriptions will be made in detail to the embodiments of the present disclosure, examples of which are illustrated in the accompanying drawings. Throughout the accompanying drawings, like reference signs represent like components or components with the same or similar functions. The embodiments described below with reference to the accompanying drawings are exemplary, and are only used for explaining the present disclosure, rather than being construed as limitations to the present disclosure.

It should be understood that the embodiments of the present disclosure are allowed to be modified. The specification should not be construed as limitations to the present disclosure, but as examples of the embodiments. Persons skilled in the art may think of other modifications within the scope and spirit of the present disclosure.

A part of the drawings included in and formed part of the specification illustrate the embodiments of the present disclosure, and are used to explain the principles of the present disclosure together with the general description given above and the detailed description of the embodiments given below.

It should also be understood that although the present disclosure has been described with reference to specific examples, and many other equivalent forms of the present disclosure can be achieved by persons skilled in the art, all these equivalent forms have the same features as the claims and therefore are within the scope of protection defined by the claims.

Specific embodiments of the present disclosure are described with reference to the drawings. However, it should be understood that the embodiments of the present disclosure are only examples of the present disclosure, which may be implemented in a variety of ways. Well-developed and/or repetitive functions and structures are not described in detail to avoid obfuscating the present disclosure with unnecessary or superfluous details. Therefore, the specific structural and functional details in the present disclosure are not intended to be restrictive, but merely serve as a basis for claims and a representative basis to inspire persons skilled in the art to use the present disclosure in a variety of ways with any substantially appropriate detailed structure.

In the related art, stoppers, such as H-shaped stoppers, are disposed at the corner of a display panel during the transportation process to position and support of the respective edges of a display panel. However, for 8K products with ultra-high resolution and frameless display panel products, the distance between the glass and the rigid circuit board is relatively short, for example, usually about 15.5 mm, and at the component-exposed edge of the display panel, the Chips On Flex (COFs) are arranged densely, for example, the distance between adjacent COFs is usually about 8.76 mm. As such, it is not possible to place the H-shaped stoppers or other stoppers at the corner of the display panel. Thus, the traditional transportation packing method cannot realize the packaging and transportation of the 8K products with ultra-high resolution and frameless display panel products. Further, it should be noted that, in the 8K products with ultra-high resolution and frameless display panel products, due to the manufacturing process, electronic components are generally exposed at one of the edges of the display panel, and this edge is usually called a component-exposed edge. Correspondingly, an edge without exposing any electronic component is called a non-component edge.

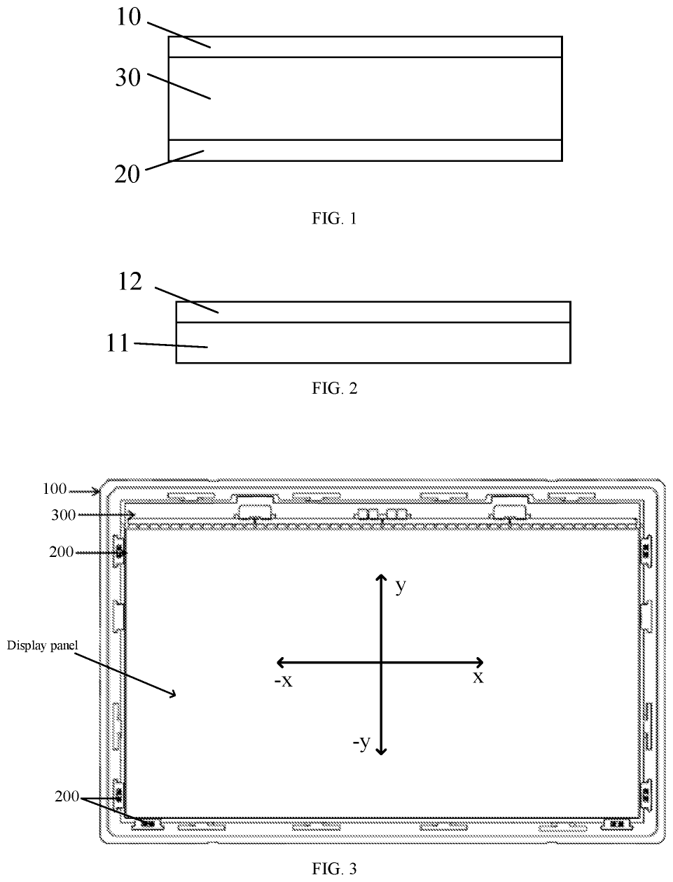

A cushion is provided in the embodiments of the present disclosure, and is used to realize an antislip function. A schematic structural diagram of the cushion is shown in FIG. 1. The cushion includes a cushion body 30, a first antislip film 10 and a second antislip film 20. A first surface of the first antislip film 10 is connected to a first surface of the cushion body 30 (that is, the upper surface of the cushion body 30 in FIG. 1); a first surface of the second antislip film 20 is connected to a second surface of the cushion body 30 (that is, the lower surface of the cushion body 30 in FIG. 1); the first surface of the cushion body is opposite to the second surface of the cushion body. Further, a second surface of the first antislip film 10 and a second surface of the second antislip film 20 are configured to respectively abut surfaces of two objects spaced apart by the cushion. For example, in a transportation process, the cushion is used to separate a package box of a transportation protective device from a display panel. In this case, one of the second surface of the first antislip film 10 and the second surface of the second antislip film 20 is abutted with a surface of the package box, and the other of the second surface of the first antislip film 10 and the second surface of the second antislip film 20 is abutted with a surface of the display panel.

Optionally, a material of the cushion body 30 includes a polyethylene foam (EPE), such as a low density polyethylene (LDPE). In this case, the cushion body 30 can be produced by extruding the low density polyethylene. In this way, the cushion body has many advantages such as waterproof, shockproof, strong toughness and strong impact resistance, and can be used as a buffer layer between the display panels in the transportation process.

In a possible implementation, a thickness of the cushion may be greater than or equal to 3 mm to ensure a good buffering performance of the cushion and prevent the buffering performance of the cushion from being affected by the serious deformation of the cushion during use. And considering the limitation of the manufacturing processes and costs of the first antislip film 10 and the second antislip film 20, the thickness of the first antislip film 10 and the second antislip film 20 may be ignored compared to the thickness of the cushion body 30. Therefore, when manufacturing the cushion body 30, the thickness thereof may be made to be greater than or equal to 3 mm to ensure the overall thickness of the cushion.

Moreover, the first surface of the first antislip film 10 and the first surface of the cushion body 30 may be fixedly connected by hot pressing, and the first surface of the second antislip film 20 and the second surface of the cushion body 30 may also be fixedly connected by hot pressing.

Optionally, materials of the first antislip film 10 and the second antislip film 20 may include an olefin block copolymers (OBC). The OBC include an olefin rubber added with a high molecular polymer. The OBC exhibits a relatively high coefficient of friction and a great antislip performance, and also has a good heat resistance which can help to improve the heat resistance performance of the cushion. In addition, in addition to the antislip performance, the OBC also have no cohesiveness, which can prevent the cushion from bonding the display panel during the automatic capture of the display panel. When using the cushion, it may be necessary to make the cushions have different antislip grades based on the different use scenarios of the cushions. In this case, the first antislip film 10 and the second antislip film 20 may be adjusted by controlling a ratio of the high molecular polymer to the olefin rubber in the OBC, to realize the adjustment on the antislip grade of the cushions. For example, in some use scenarios, to ensure that the product placed on the cushion does not slip when the inclination angle reaches 30°, the antislip grade of the cushion may be adjusted by adjusting the ratio of the high molecular polymer to the olefin rubber in the OBC to meet the transportation requirements in different cases.

Furthermore, the materials of the first antislip film 10 and the second antislip film 20 may also be doped with antistatic master batches to improve the antistatic performance of the cusion so as to enhance the transportation safety. The antistatic master batches may be made of carriers (mainly plastics, resins) and antistatic materials through high speed mixing, extrusion molding, and then pelletizing. And the antistatic master batches can reduce the surface resistance of a material to prevent the adverse effects caused by static electricity.

In a possible implementation, at least one of the first antislip film 10 or the second antislip film 20 is a film layer in a stacked configuration. For example, at least one of the first antislip film 10 or the second antislip film 20 includes a substrate and a coating which are stacked, and a target surface of the substrate is connected to the cushion body, wherein the target surface of the substrate is a surface of the substrate that is opposite to a contact surface between the substrate and the coating.

FIG. 2 shows the layered structure of the first antislip film 10. As shown in FIG. 2, the first antislip film 10 includes a first substrate 11 and a first coating 12 that are stacked, and a target surface of the first substrate 11 (that is, the lower surface of the first substrate 11 as shown in FIG. 2) is connected to the cushion body 30. Optionally, a material of the first coating 12 may include the OBC. In an embodiment, the OBC includes an olefin rubber added with a high molecular polymer. A ratio of the high molecular polymer to the olefin rubber in the OBC may be determined based on the antislip grades of the cushions. Moreover, a material of the first coating 12 may further include an antistatic master batch. For example, the first coating 12 is made of an OBC doped with an antistatic master batch. Optionally, a material of the first substrate 11 may include a low density polyethylene.

The first coating 12 is disposed on a first substrate surface of the first substrate 11 (that is, the upper surface of the first substrate 11 in FIG. 2), and after connecting first antislip film 10 with the cushion body 30, the first coating 12 is exposed as a antislip structure. A second substrate surface of the first substrate 11 (that is, the lower surface of the first substrate 11 in FIG. 2) may be connected fixedly with the first surface of the cushion body 30 by hot pressing. Here, the first substrate surface and the second substrate surface are opposite surfaces of the first substrate 11.

Based on the performance requirements of the films, a thickness of the first substrate 11 may be about 20 μm, and a thickness of the first coating 12 may be about 10 μm. It should be noted that in the actual using process, the first antislip films 10 of different thicknesses may also be fabricated according to the actual needs, and the thickness of the first substrate 11 and the first coating 12 can be adjusted. The present embodiment does not make specific restrictions on it. Here, in the embodiments of the present disclosure, the term “about” refers to ±5% of the value at issue. For example, that the thickness of the first substrate 11 is about 20 micrometers means that the thickness of the first substrate 11 may be within a range of 20 micrometers±5%, and that the thickness of the first coating 12 is about 10 micrometers means that the thickness of the first coating 12 may be within the range of 10 microns±5%.

It should be understood that a layered structure of the second antislip film 20 may be similar as the layered structure of the first antislip film 10. For example, the second antislip film 20 may include a second substrate and a second coating which are stacked. The second coating is disposed on a third substrate surface of the second substrate, wherein a fourth substrate surface of the second substrate is connected with the second surface of the cushion body 30, and the third substrate surface and the fourth substrate surface are opposite surfaces of the second substrate. Moreover, reference can be made to the materials and thicknesses of the first substrate 11 and the first coating 12 of the first antislip film 10 for the materials and thicknesses of the second substrate and the second coating, which are not repeated in detail here.

In the embodiments of the present disclosure, a new kind of cushion is designed, which includes a cushion body, a first antislip film and a second antislip film. Due to the great friction force provided by the first antislip film and the second antislip film, on the basis that the supporting performance is ensured, the cushion can further improve the friction force between the cushion and objects separated by the cushion (such as the display panel and the transportation protective device), thereby limiting the possible displacement of the objects separated by the cushion. Moreover, when using the cushion to limit the displacement of the display panel, it can also avoid problems such as the crack on the display panel caused by the stress concentration at corner when using stoppers at corner to limit the displacement of the display panel.

Some embodiments of the present disclosure provide a transportation protective device, which is used for protecting objects accommodated in the transportation protective device in the transportation process. For example, the transportation protective device is used for accommodating and protecting a display panel in the transportation process. FIG. 3 shows a schematic diagram of a transportation protective device according to an embodiment of the present disclosure. As shown in FIG. 3, the transportation protective device mainly includes a package box 100, a stopper 200, and a first cushion 300 provided in the embodiments of the present disclosure. Here, FIG. 3 shows the setup of the transportation protective device from a top view, and the detailed descriptions of each structure of the transportation protective device are provided as follows with reference to FIG. 3.

As shown in FIG. 3, the transportation protective device includes a package box, a stopper, and a first cushion. Here, the package box is configured to accommodate display panel(s). The stopper is disposed between a non-component edge of the display panel and the package box, wherein the non-component edge is an edge of the display panel where no component is exposed. The first cushion comprises a first cushion body, a first antislip film and a second antislip film; a first surface of the first antislip film is connected to a first surface of the first cushion body; a first surface of the second antislip film is connected to a second surface of the first cushion body; the first surface of the first cushion body is opposite to the second surface of the first cushion body; and a second surface of the first antislip film and a second surface of the second antislip film are configured to respectively abut the display panel and the package box. Optionally, reference can be made to the structures and implementation manners of the cushion in the foregoing embodiments for the structures and implementation manners of the first cushion, which will not be repeated here.

The package box 100 may be a hollow cubic structure with an inner cavity, and the size of the package box may be disposed according to the size of the display panel to be transported. Generally, the length, the width and the height of the inner cavity of the package box 100 may be slightly greater than the length, the width and the height of the display panel to be transported. In addition, in the transportation process of the display panel, the display panel may be placed in the inner cavity of the package box 100, with the display surface of the display panel facing up (that is, the display surface of the display panel is distal from the bottom of the package box 100) and being parallel to the bottom of the package box 100.

Optionally, a material of the package box 100 may include mixture of expanded polystyrene and expanded polyethylene (EPO). Alternatively, the package box 100 can also be made of other materials, and it is not specified in the embodiments of the present disclosure.

In addition, as the first cushion 300 is disposed between the display panel and the bottom of the package box 100, the first cushion 300 may not only paly a buffering role between the display panel and the package box 100, but also limit the displacement of the display panel relative to the package box by increasing the friction force between the first cushion 300 and the display panel and the friction force between the first cushion 300 and the package box 100 through the use of the first antislip film and the second antislip film. In a possible implementation, a size of the first cushion 300 may have a certain relationship with a size of the display panel. For example, the relationship between the size of the first cushion 300 and the size of the display panel may meet the following condition: the first cushion 300 covers an orthographic projection of the display panel onto the first cushion. That is, the surface area of the first cushion 300 in contact with the display panel may be equal to or greater than the surface area of the display panel in contact with the first cushion 300. In this way, the first cushion 300, when placed on the display panel, can completely cover the display panel, so as to ensure the friction force between the first cushion and the display panel.

Optionally, a plurality of display panels may be placed in the package box 100. In this case, the transportation protective device may further include a second cushion. The second cushion includes a second cushion body, a third antislip film and a fourth antislip film; a first surface of the third antislip film is connected to a first surface of the second cushion body; a first surface of the fourth antislip film is connected to a second surface of the second cushion body; the first surface of the second cushion body is opposite to the second surface of the second cushion body; a second surface of the third antislip film and a second surface of the fourth antislip film are configured to respectively abut two adjacent display panels in the package box. Optionally, reference can be made to the structures and implementation manners of the cushion in the foregoing embodiments for the structures and implementation manners of the second cushion, which will not be repeated here.

In addition, the relationship between the size of the second cushion and the size of the display panel may meet the following condition: the second cushion covers an orthographic projection of the display panel onto the second cushion.

In general, one or more display panels may be placed in one package box 100, and the specific number of display panels may be determined by the height and the flexural strength of the package box 100. In order to increase the flexural strength of the package box 100 in the actual use and ensure that the bending of the package box 100 is in a normal range and the package box 100 will not break due to the weight of the products during the transportation and carrying process, support profile(s) 101 may be embedded in the bottom surface of the package box 100 to increase the flexural strength of the package box 100. In a possible implementation, the support profile may include a plurality of bar profiles embedded in the bottom surface of the package box in parallel, to ensure that the plurality of bar profiles are uniformly distributed at the bottom of the package box 100, which can further increase the flexural strength of the package box 100. Further, as aluminum has great ductility and light weight, the material of the support profile 101 may include aluminum, that is, the supporting profile 101 may be made of aluminum to increase the flexural strength of the package box 100 without increasing too much weight.

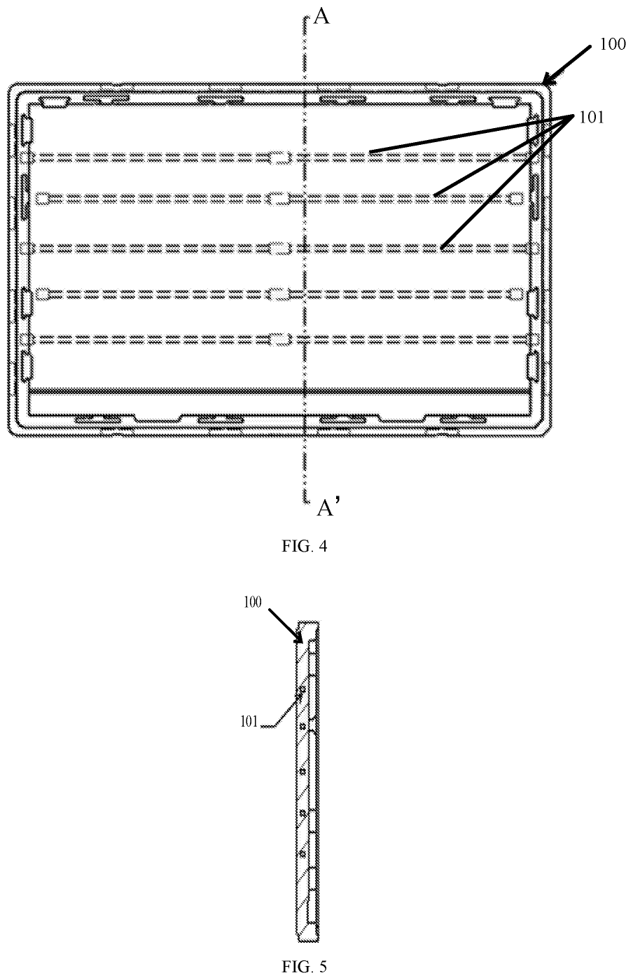

FIG. 4 shows a schematic diagram of the support profiles 101 embedded in the bottom surface of the package box 100, and FIG. 5 shows a sectional view at AA′ in FIG. 4. As shown in FIG. 4 and FIG. 5, the support profiles 101 are bar profiles and a plurality of bar profiles are uniformly embedded in the bottom surface of the package box 100 in parallel.

As shown in FIG. 3, in the actual use, in order to provide a better fixation and positioning, a plurality of stoppers 200 may be used. In this case, by mainly disposing the stoppers at edges of a first side edge and a second side edge of each display panel, a first end of the stopper 200 is controlled to abut the glass edge of the first edge or the second edge of the display panel, and a second end of the stopper 200 is controlled to abut a side wall of the inner cavity of the package box 100, such that the position of the display panel can be fixed. Here, the first end of the stopper 200 is opposite to the second end of the stopper 200. The first edge and the second edge of the display panel are opposite edges, and they are both non-component edge, that is, the edge of the display panel where no component of the circuit board is exposed. The first edge and the second edge respectively correspond to the left edge and right edge of the display panel in FIG. 3. By disposing the stoppers 200 at the first edge and the second edge, the displacement of the display panel along the −x direction and x direction can be limited.

Optionally, one or more stoppers 200 may be disposed at an edge opposite to the component-exposed edge of the display panel. For example, one or more stoppers 200 are disposed at the lower edge of the display panel in FIG. 3 to limit the displacement of the display panel along the −y direction.

It should be noted that, in order to further ensure the limiting effect of transportation protective device on the displacement of the display panel, the relationship between the transportation direction and the placement mode of the display panels disposed in the transportation protective device may also be limited. In the embodiments of the present disclosure, in the transportation process of the display panel, the extending direction of the first edge and the extending direction of the second edge may be perpendicular to the transportation direction, and the extending direction of the third edge and the extending direction of the fourth edge may be the same as the transportation direction. Here, the third edge and the fourth edge are opposite edges of the display panel, corresponding to the upper edge and the lower edge of the display panel in FIG. 3 respectively, and one of the third edge and the fourth edge is the component-exposed edge.

In this way, as the first edge and the second edge are provided with the stoppers 200, and the cushion 300 can provide friction force for the display panels, under the combined effect of friction force provided by the stoppers 200 and the cushion 300, the displacement of the display panel along the transport direction can be greatly limited and the effectiveness of the limiting effect of the transportation protective device can be ensured. For example, in the transportation process, if the third edge and the fourth edge are not provided with any stoppers 200, and only the friction force provided by the cushion 300 is used for fixing the position of the display panel along the corresponding direction, when the device is transported along they direction or −y direction of the coordinate system in FIG. 3, sudden braking or rapid acceleration during transportation will easily make the display panel break through the friction force of the cushion 300 under the effect of inertia, causing the component-exposed edge of the display panel to collide with the inner wall of the packing box 100. Therefore, in the embodiments of the present disclosure, by controlling the extending direction of the first edge and the extending direction of the second edge to be perpendicular to the transportation direction, and controlling the extending direction of the third edge and the extending direction of the fourth edge to be the same as the transportation direction, the display panel is only possible to displace along the x direction or −x direction in the transportation process. However, due to the presence of the stoppers 200, the displacement of the display panel along the x direction or −x direction can be limited by the stoppers 200, and the slight displacement of the display panel along they direction or −y direction can be limited by the friction force between the cushion 300 and the display panel.

In the embodiments of the present disclosure, a transportation protective device including a cushion is designed. The cushion includes a cushion body, a first antislip film and a second antislip film. Due to the great friction force provided by the first antislip film and the second antislip film, on the basis that the supporting performance is ensured, the cushion can further improve the friction force between the cushion and objects separated by the cushion (such as the display panel and the transportation protective device), thereby limiting the possible displacement of the objects separated by the cushion. Moreover, when using the cushion to limit the displacement of the display panel, it can also avoid problems such as the crack on the display panel caused by the stress concentration at corner when using stoppers at corner to limit the displacement of the display panel. In addition, by limiting the relationship between the placement mode and the transportation direction of transportation protective device, it can prevent the display panel from moving in the packaging box due to turning and sudden braking during transportation, which further ensures the limiting effect of the transportation protection device on the displacement of the display panel.

It should be noted that the display panel in the embodiments of the present disclosure may be a display panel of any display device with a display function, such as electronic paper, a mobile phone, a tablet computer, a television, a monitor, a laptop computer, a digital photo frame, a navigator, etc. In addition, the display device may be the 8K product with ultra-high resolution, a frameless display panel product, or other types of products, which are not specified in the embodiments of the present disclosure.

Described above are the detailed descriptions of various embodiments of the present disclosure, and the present disclosure is not limited to these specific embodiments. Those skilled in the art may derive a plurality of variants and modifications based on the concept of the present disclosure, and these variants and modifications should fall within the scope of protection of the present disclosure.

In the descriptions of the present specification, the orientation or positional relations indicated via terms of “above”, “under”, and the like are based on orientation or the positional relations shown in the drawings. They are merely for the purpose of being convenient to describe the present disclosure, but not to require that the present disclosure must be constructed and operated with the particular orientation, so that they should not be construed as limitations on the present disclosure.

It should also be noted that in the specification, the terms “first” and “second” are only used for the purpose of description and should not be construed as indicating or implying relative importance or implicitly indicating the number of technical features as indicated.

What is claimed is:

1. A cushion, comprising a cushion body, a first antislip film and a second antislip film,
wherein a first surface of the first antislip film is connected to a first surface of the cushion body; a first surface of the second antislip film is connected to a second surface of the cushion body; the first surface of the cushion body is opposite to the second surface of the cushion body; and a second surface of the first antislip film and a second surface of the second antislip film are configured to respectively abut surfaces of two objects spaced apart by the cushion.

2. The cushion according to claim 1, wherein at least one of the first antislip film and the second antislip film comprises a substrate and a coating that are stacked; and a target surface of the substrate is connected to the cushion body, the target surface of the substrate being a surface of the substrate that is opposite to a contact surface between the substrate and the coating.

3. The cushion according to claim 2, wherein a material of the coating comprises an olefin block copolymer.

4. The cushion according to claim 3, wherein the olefin block copolymer comprises an olefin rubber added with a high molecular polymer; a ratio of the high molecular polymer to the olefin rubber is determined based on an antislip grade of the cushion.

5. The cushion according to claim 3, wherein the material of the coating further comprises an antistatic master batch.

6. The cushion according to claim 2, wherein a material of the substrate comprises a low density polyethylene.

7. The cushion according to claim 2, wherein a thickness of the substrate is about 20 μm.

8. The cushion according to claim 2, wherein a thickness of the coating is about 10 μm.

9. The cushion according to claim 1, wherein the cushion body and the first antislip film are fixedly connected by hot pressing, and the cushion body and the second antislip film are fixedly connected by hot pressing.

10. The cushion according to claim 1, wherein a thickness of the cushion is greater than or equal to 3 mm.

11. The cushion according to claim 1, wherein a material of the cushion body comprises a polyethylene foam.

12. A transportation protective device, comprising:
a package box configured to accommodate a display panel;
a stopper disposed between a non-component edge of the display panel and the package box, the non-component edge being an edge of the display panel where no component is exposed;
a first cushion, wherein the first cushion comprises a first cushion body, a first antislip film and a second antislip film; a first surface of the first antislip film is connected to a first surface of the first cushion body; a first surface of the second antislip film is connected to a second surface of the first cushion body; the first surface of the first cushion body is opposite to the second surface of the first cushion body; and a second surface of the first antislip film and a second surface of the second antislip film are configured to respectively abut the display panel and the package box.

13. The transportation protective device according to claim 12, wherein the first cushion covers an orthographic projection of the display panel onto the first cushion.

14. The transportation protective device according to claim 12, wherein the transportation protective device further comprises a second cushion including a second cushion body, a third antislip film and a fourth antislip film; a first surface of the third antislip film is connected to a first surface of the second cushion body; a first surface of the fourth antislip film is connected to a second surface of the second cushion body; the first surface of the second cushion body is opposite to the second surface of the second cushion body; a second surface of the third antislip film and a second surface of the fourth antislip film are configured to respectively abut two adjacent display panels in the package box.

15. The transportation protective device according to claim 14, wherein the second cushion covers an orthographic projection of the display panel onto the second cushion.

16. The transportation protective device according to claim 12, wherein an extending direction of a component-exposed edge of the display panel is the same as a transportation direction of the device, the component-exposed edge being an edge of the display panel where a component is exposed.

17. The transportation protective device according to claim 12, wherein a display surface of the display panel faces away from a bottom of the package box.

18. The transportation protective device according to claim 12, wherein a support profile is embedded in a bottom surface of the package box.

19. The transportation protective device according to claim 18, wherein the support profile comprises a plurality of bar profiles embedded in the bottom surface of the package box in parallel.

20. The transportation protective device according to claim 18, wherein a material of the support profile comprises aluminum.
